(19) United States
(12) Patent Application Publication
(10) Pub. No.: US 2009/0179870 A1
(43) Pub. Date: Jul. 16, 2009

(54) Luminous touch screen with interstitial layers

(75) Inventors: Willaim F. Scholz, Scottsdale, AZ (US); Oscar Ozuna Sanchez, Tempe, AZ (US); David A. Hardinger, Apache Junction, AZ (US)

Correspondence Address: Paul F. Wille;Cantor Colburn LLP, 20 Church St., 22nd Floor, Hartford, CT, 06103-3207, US

(73) Assignee: World Properties, Inc., Lincolnwood, IL (US)

(21) Appl. No.: 12/009,060

(22) Filed: Jan. 16, 2008

(51) Int. Cl. G06F 3/045; G06F 3/041

(52) U.S. Cl. 345/174; 345/173

(57) ABSTRACT

A luminous touch screen includes a light guide having a light extracting feature on a first major surface and an interstitial layer on a second major surface. A touch screen overlies the interstitial layer. The light guide has an index of refraction, n₁, the interstitial layer has an index of refraction, n₂, and n₁>n₂. The interstitial layer is preferably a layer of resin bearing ink, which is cured or dried after deposition.

### FIELD OF THE INVENTION

This invention relates to light guides for luminous touch screens and, in particular, to an interstitial layer between a light guide and a touch screen.

### BACKGROUND OF THE INVENTION

In a personal electronic device, such as a hand-held computer or a laptop computer, a touch screen is often used as an input device. The touch screen is a separate device or is built into the personal electronic device. A touch screen uses a capacitive element or a piezo-resistive element to indicate a point of contact between a user's finger and the surface of the touch screen. The location is calculated by a microcontroller in the touch screen or in the personal electronic device. The location, or a series of locations, is then used for control or as data entry.

Literally, “touch screen” can include membrane switches but this is not the meaning of the words in the art. As used herein, a touch screen is a device that does not have predefined contact areas but has a single area in which touch is detected and, typically, the location of a touch is measured. Sophisticated systems can measure the force of a touch.

In the prior art, U.S. Pat. No. 6,433,846 (Omar et al.) discloses the combination of a liquid crystal display overlying a touch screen, wherein both are back lit by a gas discharge lamp and a light guide. U.S. Pat. No. 6,822,640 (Derocher) discloses a touch screen back lit by an electroluminescent (EL) lamp. U.S. Pat. No. 6,842,170 (Akins et al.) discloses a liquid crystal display, an EL lamp, and a touch screen arranged in several permutations. Published Patent Application 2004/0075779 (Paukshto et al.) discloses a touch screen overlying a back lit liquid crystal display. A back lit piezo-resistive touch screen is currently an impossibility because known piezo-resistive materials are opaque. A back lit touch screen must be transparent. Edge lit sheets, or light guides, for back lighting have long been known in the art; e.g. U.S. Pat. Nos. 3,027,669 (Hardesty) and 3,356,839 (Mehess et al.). Edge lit keypads are also known in the art. For example, U.S. Pat. No. 4,247,747 (Swatten) discloses light emitting diodes (LEDs) optically coupled to a polyester sheet having a thickness of seven mils (0.18 mm). U.S. Pat. No. 5,975,711 (Parker et al.) discloses a light conductive panel coupled to a light source.

Edge lit sheets conduct light from an edge, relying mostly on what is known as total internal reflection. (There is also some direct transmission). Total internal reflection is obtained when light is incident upon a surface at greater than a critical angle from perpendicular. The critical angle is given by the following equation, in which n₂ is the index of refraction of the surrounding medium and n₁ is the index of refraction of the sheet.

$${θ}_{c} = {sin}^{- 1} ( \frac{{n}_{2}}{{n}_{1}} )$$

Obviously, n₁≧n₂ because the limits of positive arcsine are 0 and +1. Air (n₂=1) is typically used around light guides but providing separation makes construction awkward. It is known to use a reflecting layer, such as aluminum, as a “cladding layer” to simulate total internal reflection in light guides. Published Patent Application 2005/0210643 (Mezei et al.) discloses using white or “reflecting” paint for a reflector. Published Patent Application 2004/0251567 (Cappellini et al.) discloses Superflex™ 2500 resin as a cladding material for optical fiber and discloses that the resin has a refractive index of 1.35-1.41.

A light extracting feature is anything that interferes with total internal reflection. One or more such features are located on a major surface of a sheet for lighting discrete areas. Alternatively, an entire surface can be used to extract light. U.S. Pat. No. 4,183,628 (Laesser et al.) discloses a watch that is back lit by a light source coupled to the edge of a “frost glass” having scratches on its lower surface to redirect light up through a display. U.S. Pat. No. 5,550,676 (Ohe et al.) discloses an edge lit light guide having graduated features to compensate for distance from a light source.

Screen printing is long known in the art for making a variety of products, such as electroluminescent (EL) lamps. The inks used for making EL lamps include a binder, a solvent, and a filler, wherein the filler determines the nature of the ink (e.g. carbon for conductive layers, barium titanate for dielectric layers). The inks are printed and cured (dried) to form each layer in an EL lamp.

Screen printed panels larger than 45-60 cm. on a side are rare. Within the size limitation, screen printing is a low cost, well developed art. The opportunity exists to make touch screens at reduced cost by employing screen printing technology. It may seem straightforward to screen print a touch screen on a light guide and have a luminous touch screen for a liquid crystal display. Unfortunately, the reality is somewhat different. The electrical requirements of a touch screen may not be compatible with a liquid crystal display and neither may be compatible with the optical requirements of a light guide.

As used herein, “transparent” does not imply a particular level of light transmission. The amount of light transmission that is suitable depends, for example, on the size (largest dimension) of the light guide or the contrast of a graphic.

In view of the foregoing, it is therefore an object of the invention to provide improved lighting for touch screens.

Another object of the invention is to provide a combined luminous sheet and touch screen that is more easily constructed than in the prior art.

### SUMMARY OF THE INVENTION

The foregoing objects are achieved by this invention in which a luminous touch screen includes a light guide having at least one light extracting feature on a first major surface and an interstitial layer on a second major surface. A touch screen overlies the interstitial layer. The light guide has an index of refraction, n₁, the interstitial layer has an index of refraction, n₂, and n₁>n₂. The interstitial layer is preferably a layer of resin bearing ink, which is cured or dried after deposition.

### BRIEF DESCRIPTION OF THE DRAWINGS

A more complete understanding of the invention can be obtained by considering the following detailed description in conjunction with the accompanying drawings, in which:

FIG. 1 is a cross-section of a luminous touch screen constructed in accordance with the invention;

FIG. 2 is a cross-section of a luminous touch screen constructed in accordance with a preferred embodiment of the invention;

FIG. 3 is a cross-section of a luminous touch screen constructed in accordance with an alternative embodiment of the invention;

FIG. 4 is a cross-section of a luminous touch screen constructed in accordance with another alternative embodiment of the invention; and

FIG. 5 is a cross-section of a luminous touch screen constructed in accordance with another alternative embodiment of the invention.

### DETAILED DESCRIPTION OF THE INVENTION

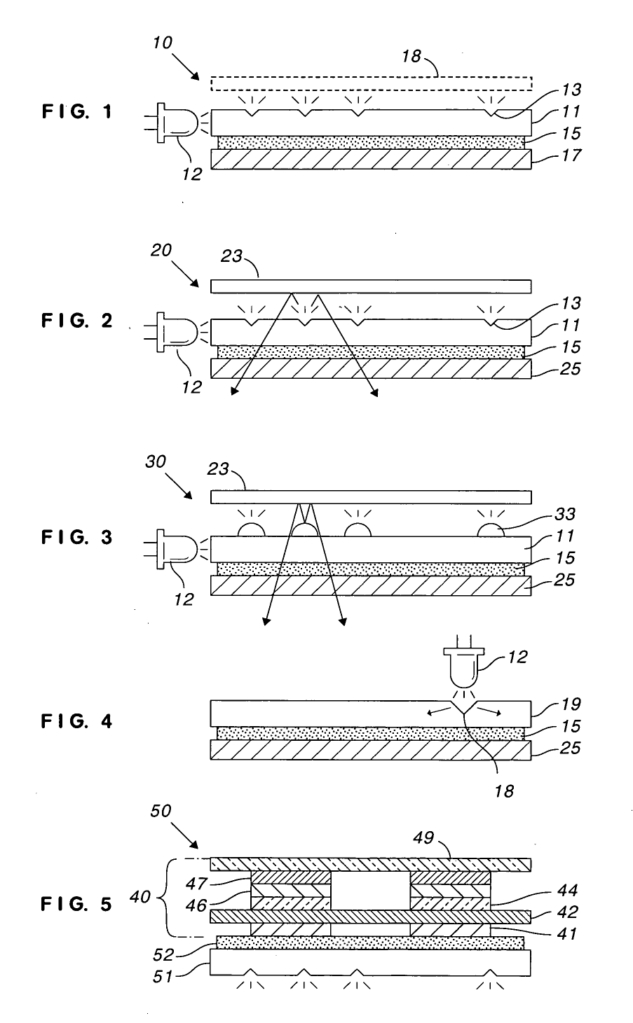

In FIG. 1, display 10 includes light guide 11 adjacent a source of light, such as LED 12. Light guide 11 is a sheet, preferably of polycarbonate (n≈1.5), although other transparent plastics can be used instead. The light source can be a single LED, a plurality of LEDs arranged along the edge of the light guide, or a diffuse source, such as a fluorescent lamp, depending upon the size of the display and other factors.

In accordance with a first aspect of the invention, light extracting features, such as feature 13, are imprinted on a first major surface of light guide 11. Light guide 11 includes a second major surface joined to the first major surface along an edge adjacent LED 12. In the embodiment illustrated in FIG. 1, the first major surface is the upper surface of light guide 11. The features are grooves or depressions formed in the first major surface, forming discontinuities that interfere with total internal reflection at the location of the feature.

In accordance with a second aspect of the invention, interstitial layer 15 is a cured layer of resin bearing ink on a second major surface of light guide 11. Interstitial layer 15 has a lower index of refraction than light guide 11, preferably at least 0.1 lower. As known in the art, amorphous polymers have a lower index of refraction than partially or completely crystalline polymers, in which the molecules are more densely packed. Thus, amorphous forms of, for example, polytetrafluorethylene (PTFE) are preferred for the interstitial layer. In one embodiment of the invention a layer of Superflex™ 2500 resin having a thickness of approximately 5 μm was used as an interstitial layer. Thinner layers are not preferred. There is no operational or functional upper limit to thickness. Practical considerations, such as cost and ease of manufacture, provide an upper limit.

Touch screen 17 is preferably what is known as a capacitive touch screen, although any type of touch screen can be used in the embodiment illustrated in FIG. 1 because light is being emitted upwardly. Touch screen 17 contacts interstitial layer 15 and is optically separated from light guide 11.

Optional transparent layer 18 overlies light guide 11 and is back lit by light extracting features 13. Layer 18 is preferably the same material as interstitial layer 15 and has graphics printed thereon. Alternatively, layer 18 is an interstitial layer between a sheet (not shown) containing graphics and light guide 11. This allows a sheet containing graphics to have any index of refraction without concern for it matching the index of refraction of light guide 11. As another alternative, layer 18 is not the same material as interstitial layer 15 but has an index of refraction lower than the index of refraction of light guide 11.

In FIG. 2, reflector 23 is positioned adjacent the first major surface and light is reflected downwardly. Touch screen 25 is transparent, such as a capacitive touch screen. The embodiment of FIG. 2 permits direct access to touch screen 25, rather than through several other layers, and permits one to use thicker or stiffer light guides than the embodiment of FIG. 1.

In FIG. 3, luminous touch screen 30 includes light extracting features, such as feature 33, screen printed on a first major surface of light guide 11. The features include a resin having an index of refraction approximately the same as the index of refraction of light guide 11, thereby interfering with total internal reflection at the location of the feature. In one embodiment of the invention, barium titanate was added to the resin to diffuse the extracted light. The embodiment of FIG. 3 operates in the same manner as the embodiment of FIG. 2.

FIG. 4 illustrates an alternative embodiment of the invention in which light enters the light guide through a major surface instead of through an edge. A graphic layer or a reflector, and light extracting features are omitted for clarity but can be included in this embodiment. Light emitted from a light source, such as LED 12, is injected into light guide 19. As illustrated in FIG. 4, the first major surface includes depression 18, which causes light from LED 12 to refract and become trapped in light guide 19. Light extracting features (not shown in FIG. 4) also occupy the first major surface.

The embodiments illustrated in FIGS. 1-4 can be made by roll coating or screen printing, both economical methods. In FIG. 5, screen printing is used to provide patterned layers for a capacitive touch screen. Luminous touch screen 50 includes light guide 51, interstitial layer 52, and touch screen 40. Light guide 51 is preferably a sheet of polycarbonate. Interstitial layer 52 was printed from a solution of Superflex™ 2500 resin in DMAc (dimethylacetamide). The resin is a type of PVDF (polyvinylidene fluoride) commercially available from Arkema Inc. A dilution rate of 50-70 percent is suitable for making the ink.

Overlying interstitial layer 52 is touch screen 40, including front electrode layer 41. Layer 41 is screen printed in a pattern of columns across the surface of interstitial layer 52. Layer 41 is a transparent, conductive layer made from PEDOT (poly-3,4-ethylenedioxythiophene), for example. Overlying layer 41 is bus bar layer 42, printed from a conductive ink containing carbon or silver. Overlying bus bar 42 is clear, UV curable insulating layer 44.

Rear electrode layer 46 and rear bus bar layer 47 overlie insulating layer 44. Insulating or protective layer 49 overlies rear electrode layer 47. Layers 46 and 47 are screen printed in a pattern of rows, providing an X-Y grid for the touch screen. Interstitial layer 52 isolates front electrode layer 41 from light guide 51 and improves the efficiency of the light guide; that is, light guide 51 provides more light at the light extraction features with interstitial layer 52 than without layer 52.

The invention thus provides an improved luminous touch screen that is constructed more easily and at lower cost than in the prior art.

Having thus described the invention, it will be apparent to those of skill in the art that various modifications can be made within the scope of the invention. For example, diffusing agents, such as barium titanate, or dyes, or other agents, can be added to the light extracting features to affect the extracted light. Optical coupling can be used to gather more light into the light guide. Depending upon need, e.g. because of limited space, light can be reflected from a source prior to entering the light guide. By extending the light guide past the interstitial layer and the touch screen, one can inject light through the second major surface.

What is claimed is:

1. A luminous touch screen comprising:
a light guide in the form of a sheet having a first major surface, a second major surface, and at least one edge;
a light source for injecting light into said light guide;
at least one light extracting feature on said first major surface;
an interstitial layer on said second major surface; and
a touch screen on said interstitial layer;
wherein the light guide has an index of refraction, n₁, the interstitial layer has an index of refraction, n₂, and wherein n₁≧(n₂+0.1).

2. The luminous touch screen as set forth in claim 1 and further including a reflector overlying the first major surface.

3. The luminous touch screen as set forth in claim 1 wherein said touch screen is opaque.

4. The luminous touch screen as set forth in claim 1 wherein said touch screen is transparent.

5. The luminous touch screen as set forth in claim 4 wherein said touch screen is capacitive.

6. The luminous touch screen as set forth in claim 1 wherein said at least one light extracting feature is a discontinuity in said first major surface.

7. The luminous touch screen as set forth in claim 1 wherein said at least one light extracting feature is cured ink on said first major surface.

8. The luminous touch screen as set forth in claim 1 wherein said interstitial layer is a cured, resin bearing ink.

9. The luminous touch screen as set forth in claim 8 wherein said cured, resin bearing ink includes polyvinylidene fluoride.

10. The luminous touch screen as set forth in claim 1 wherein light from said light source enters said light guide through one of said first major surface and said second major surface.

11. The luminous touch screen as set forth in claim 10 wherein light from said light source enters said light guide through said first major surface.

12. The luminous touch screen as set forth in claim 1 wherein light from said light source enters said light guide through said edge.

13. The luminous touch screen as set forth in claim 12 wherein said light source includes at least one light emitting diode.

14. The luminous touch screen as set forth in claim 1 and further including a transparent layer overlying the first major surface.

15. The luminous touch screen as set forth in claim 14 wherein said transparent layer includes graphics.

16. The luminous touch screen as set forth in claim 14 wherein said transparent layer is the same material as said interstitial layer.
